(19) United States
(12) Patent Application Publication
(10) Pub. No.: US 2024/0157324 A1
(43) Pub. Date: May 16, 2024

(54) METHODS FOR PRODUCING METAL FLOW REACTOR MODULES WITH INTEGRATED TEMPERATURE CONTROL AND MODULES PRODUCED

(71) Applicant: CORNING INCORPORATED, CORNING, NY (US)

(72) Inventors: George Edward Berkey, Pine City, NY (US); Richard Alan Quinn, Horseheads, NY (US)

(21) Appl. No.: 18/283,856

(22) PCT Filed: Mar. 22, 2022
(86) PCT No.: PCT/US2022/021279

§ 371 Date: Sep. 25, 2023

Related U.S. Application Data
(60) Provisional application No. 63/167,154, filed on Mar. 29, 2021.

(51) Int. Cl. B01J 19/00; B23K 20/00; B23K 20/02; B23K 20/16; B23K 20/22; B23K 103/04

(52) U.S. Cl. CPC B01J 19/0053; B23K 20/002; B23K 20/023; B23K 20/16; B23K 20/22; B23K 2103/05

(57) ABSTRACT

A method for forming a metal flow module includes forming a flux retention feature on a first major surface of a first metal plate and then applying flux to the first major surface. The flux retention feature is configured to retain the flux at least in part on the first surface. The method further includes positioning a second major surface of a second metal plate against the first major surface of the first metal plate. The second metal plate has one or more flow channels defined at least in part in the second major surface. The flux is positioned between first contacting portions of the first and second major surfaces. The method further includes heating the first and second metal plates in a non-oxidizing atmosphere to thermally bond the first contacting portions.

### CROSS-REFERENCE TO RELATED APPLICATIONS

This application claims the benefit of priority under 35 U.S.C. § 119 of U.S. Provisional Application No. 63/167,154, filed Mar. 29, 2021, the content of which is incorporated herein by reference in its entirety.

### FIELD OF THE DISCLOSURE

The disclosure relates to methods for producing metal flow modules useful in flow reactors, and more particularly to efficient, low cost methods of producing metal flow modules, particularly stainless steel flow modules featuring enclosed through-passages in a stainless steel module body with integrated cooling.

### BACKGROUND

Large surface-to-volume ratio offered by micro- and milli-meter and even smaller centimeter scale channel geometries can intensify mass and heat transfer, often reducing reaction times to seconds instead of minutes or hours compared to conventional batch processing. The intensification serves to increase the reaction rate and thus increase the rate of product synthesis per reaction volume. Continuous flow reactors employing such channels have found increasingly wide applications in organic synthesis on all scales as well as in other chemical processing applications.

Rapidly growing interest can be attributed to a range of advantages offered by such devices. Compared to traditional batch reactors, continuous flow reactors employing modules with micro- and milli-meter scale—or even small centimeter scale channels—typically exhibit enhanced heat and mass transfer, improved safety, and higher levels of controllability. Furthermore, multiple reaction steps, purification steps and analysis can often be combined into a single continuous production unit.

Flow systems are usually assembled from relatively simple, off-the-shelf components, such as polymer or metal tubing in combination with standard connectors to join the flow reactor modules together. These components, which are readily available and cheap, allow only limited design complexity for process intensification applications, particularly where intense mass transfer or heat exchange is desired. More elaborate channel architectures can be provided within flow reactor modules. Several structural elements, such as mixing structures, residence time channels, separation units and interfaces for in-line analysis, have been incorporated into these devices.

Flow reactor modules are commercially available in various pre-determined designs formed in various inert materials (most commonly glass, stainless steel/Hastelloy® metal, or silicon carbide ceramic). The modules may be manufactured by various techniques, such as micromachining, laser ablation, etching, laser sintering, and molding—methods which are not particularly low cost. One relatively low-cost manufacturing method is to machine channels into one or two mating surfaces of cooperating metal plates, then seal mating surfaces of the plates together with a compressed elastomeric gasket. While relatively low cost, this sealing approach has inherent limits on operating temperatures and pressures of the fluidic modules.

The intensified reactions in some flow systems are extremely exothermic and auxiliary cooling can be required to safely and efficiently carry out the reactions. The auxiliary cooling can include a cooling jacket that dads both sides of the reactor module. The cooling jacket can include elastomeric gaskets at the input and output ports to the cooling jacket and at the mating surfaces between the cooling jacket and the sides of the fluidic module. While similarly low cost, this sealing approach imposes limits on the operating temperatures and pressures of the cooling jacket. A lower cost method of manufacturing high performance flow reactors is desirable.

### SUMMARY OF THE DISCLOSURE

According to some aspects of the present disclosure, a method for forming a metal flow module includes forming a flux retention feature on a first major surface of a first metal plate, applying flux to a first major surface of a first metal plate, positioning a second major surface of a second metal plate against the first major surface of the first metal plate, the second metal plate having one or more flow channels defined at least in part in the second major surface, the flux positioned between first contacting portions of the first and second major surfaces, and heating the first and second metal plates in a non-oxidizing atmosphere to thermally bond the first contacting portions.

In embodiments, the first metal plate can also have one or more flow channels defined at least in part in the first major surface and aligned with the one or more channels defined in the second major surface.

In embodiments, the flux comprises a carbide powder or nitride powder. A carbide powder or a carbide powder mixture is most preferred, specifically one comprising boron carbide.

In embodiments, heating the plates is performed while simultaneously pressing the plates together. Alternatively, the plates can be mechanically fastened together prior to heating the plates, such as by joining the plates with fasteners positioned around the perimeter thereof, or both around the perimeter thereof and in selected locations in the middle or center.

In embodiments, at least portions of the major surfaces of the first and second plates can be coated with a chemically resistant coating prior to positioning the first and second plates against one another. The portions correspond, defined as align to, to locations of the flow channels. Alternatively, after heating the plates together in a non-oxidizing atmosphere to thermally bond the contacting portions of the respective major surfaces of the first and second metal plates, the flow channels can then be coated with the chemically resistant coating. In either case, the chemically resistant coating is desirable and includes a carbide coating, preferably silicon carbide.

In embodiments, the method further comprises forming in the major surface of the first plate the one or more flow channels defined at least in part in the major surface, such as by machining.

In embodiments, the method further includes applying flux to a portion of a fluid connector, connecting the fluid connector to one of the first and second metal plates so that the fluid connector fluidically communicates with the one or more flow channels, the flux positioned between second contacting portions of the portion of fluid connector and the one of the first and second metal plates, and heating the fluid connector and the first and second metal plates in the non-oxidizing atmosphere to thermally bond the first and second contacting portions.

In embodiments, the method further includes applying flux to a third major surface, opposed to the second major surface, of the second metal plate, positioning a fourth major surface of a third metal plate against the third major surface of the second metal plate, the third metal plate having one or more flow channels defined at least in part in the fourth major surface, the flux positioned between second contacting portions of the third and fourth major surfaces, and heating the first, second, and third metal plates in the non-oxidizing atmosphere to thermally bond the first and second contacting portions.

In embodiments, the method further includes applying flux to a third major surface of a third metal plate, positioning a fourth major surface, opposed to the first major surface, of the first metal plate against the third major surface of the third metal plate, the first metal plate having one or more flow channels defined at least in part in the fourth major surface, the flux positioned between second contacting portions of the third and fourth major surfaces, and heating the first, second, and third metal plates in the non-oxidizing atmosphere to thermally bond the first and second contacting portions.

In other embodiments, a flow module for a flow reactor or other fluidic processing includes a first metal plate having a first major surface, a second metal plate having a second major surface and one or more flow channels defined at least in part in the second major surface, the first and second metal plates joined by a flux bond at first contacting portions of the first and second major surfaces.

In other embodiments, the flow module further includes a third metal plate having a third major surface and one or more flow channels defined at least in part in the third major surface, the second and third metal plates joined by a flux bond at second contacting portions of the third major surface and a fourth major surface, opposed to the second major surface, of the second metal plate.

In other embodiments, the flow module further includes a third metal plate having a third major surface, the first metal plate having one or more flow channels defined at least in part in a fourth major surface, opposed to the first major surface, of the first metal plate, the first and third metal plates joined by a flux bond at second contacting portions of the third and fourth major surfaces.

In yet further embodiments, the flow module further includes a fourth metal plate having a fifth major surface and one or more flow channels defined at least in part in the fifth major surface, the second and fourth metal plates joined by a flux bond at third contacting portions of the fifth major surface and a sixth major surface, opposed to the second major surface, of the second metal plate.

In still another embodiment, a flow module useful in a flow reactor or for other fluidic processing is provided, the flow module comprising a first metal plate having opposing first and second major surfaces and a second metal plate having opposing first and second major surfaces and one or more flow channels defined at least in part in the first major surface, the plates joined together with their respective first major surfaces facing each other by flux-assisted interdiffusion and/or co-melting of the facing surfaces.

The methods and modules of the present disclosure produced provide a low-cost method to produce a metal or stainless steel flow reactor module. If embedded fluid couplers are included, users have a simple way of connecting to the module, and the process of embedding is likewise simple and produces a robust seal between the couplers and the consolidated plate. The methods and modules also provide a flow reactor module which is sealed or enclosed without the use of organic materials such as gaskets or O-rings, allowing for performance high temperature processes or reactions, or other processes or reactions incompatible with organic materials.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are exemplary and intended only to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a flow diagram illustrating a method of forming a flow module according to aspects of the present disclosure;

FIG. 2 is a digital photograph of an embodiment of a metal plate according to aspects of the current disclosure, the plate having one or more channels machined therein;

FIG. 3 is a digital photograph of an embodiment of a flow module according to aspects of the present disclosure;

FIG. 4 is a digital photograph of another embodiment of a flow module according to aspects of the present disclosure;

FIG. 5 is a close up digital photograph of an edge of an embodiment of a flow module according to aspects of the present disclosure showing a seal between first and second plates of the module;

FIG. 6 is an exploded perspective view schematically illustrating aspects of forming a flow module according to the disclosure;

FIG. 7 is a simplified schematic section cut of a flow module according to aspects of the invention, depicting a geometry of a flow channel extending through flow module;

FIG. 8 is a flow diagram illustrating a continuation of the method of FIG. 1 when a flow module includes integrated cooling; and

FIG. 9 is an exploded perspective view schematically illustrating aspects of forming a flow module with integrated cooling according to the disclosure.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an endpoint of a range, the disclosure should be understood to include the specific value or endpoint referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

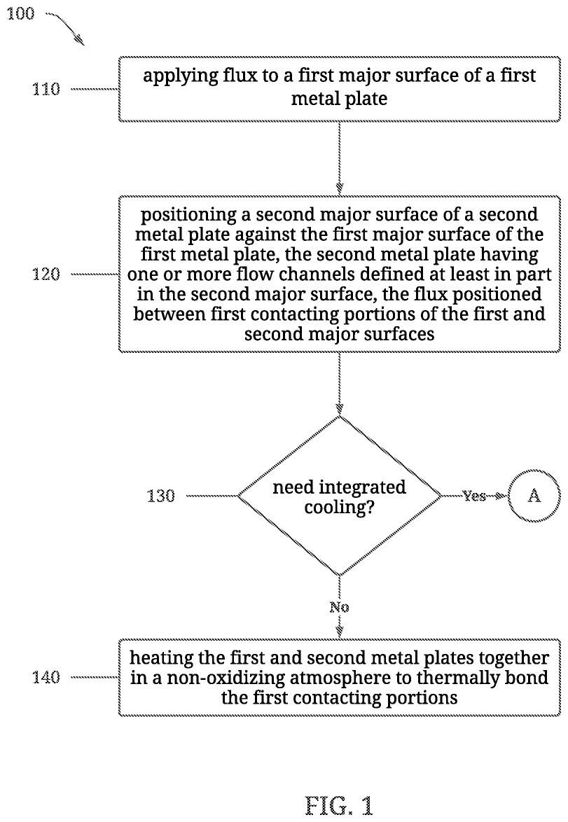

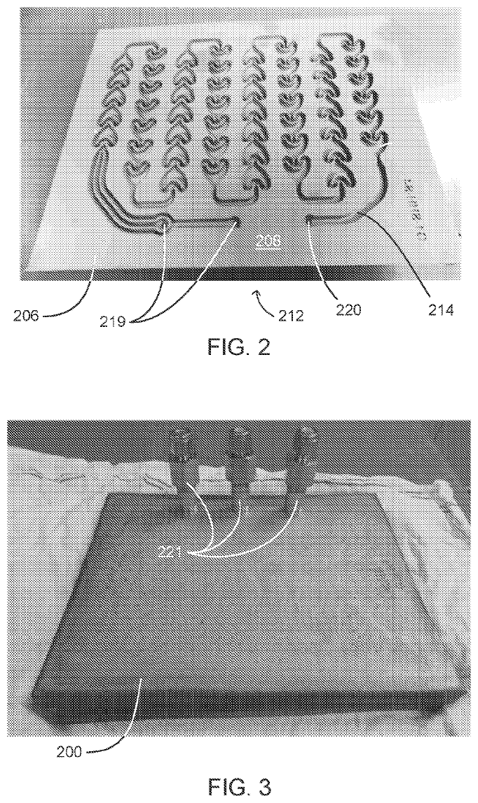

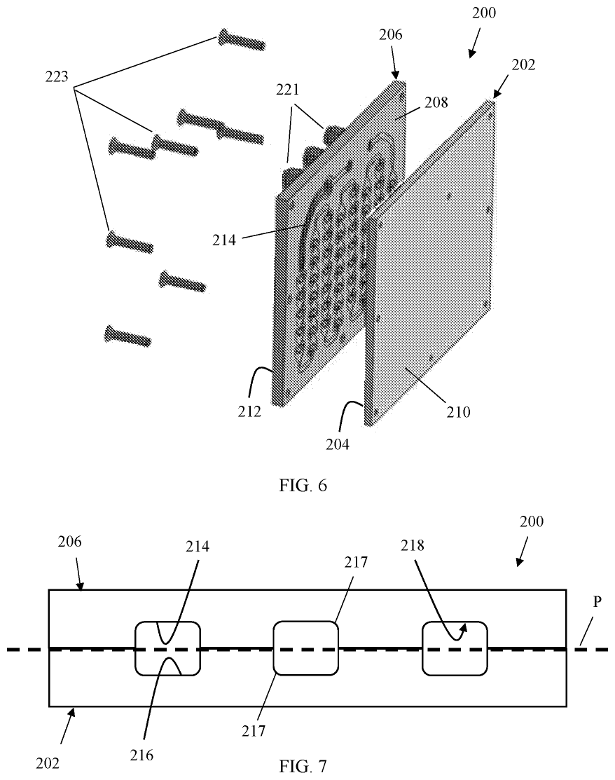

FIG. 1 illustrates a flow diagram of a method 100 for forming a metal flow module. The method 100 is described with reference to FIGS. 2-7, which illustrate embodiments of a metal flow module 200. The metal flow module 200 includes a first metal plate 202 with a first major surface 204 and a second metal plate 206 with a second major surface 208. The first metal plate 202 has a third major surface 210 that is opposed to the first major surface 204. The second metal plate 206 has a fourth major surface 212 that is opposed to the second major surface 208. The second metal plate 206 also has one or more flow channels 214 defined at least in part in the second major surface 208. The first metal plate 202 in some embodiments also has one or more flow channels 216 defined at least in part in the first major surface 204.

The method 100 as shown in FIG. 1 includes the step 110 of applying flux to the first major surface 204 of the first metal plate 202. The method 100 then includes the step 120 of positioning the first major surface 204 of the first metal plate 202 against the second major surface 208 of the second metal plate 206. In this arrangement, the first and second major surfaces 204, 208 face one another and the flux is positioned between first contacting portions of the first and second major surfaces. As used herein, (first, second, etc.) “contacting portions” means those portions of the referenced surfaces that would be in contact absent the flux when the referenced surfaces are positioned against one another. Specifically, the first contacting regions are those portions of the respective first and second major surfaces 204, 208 that would be in contact absent the flux when the first major surface 204 is positioned against the second major surface 208.

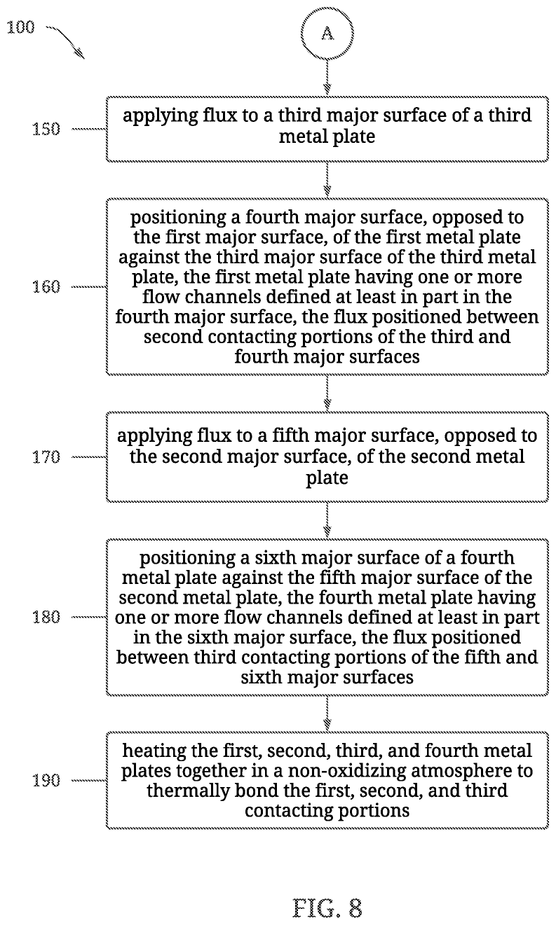

In embodiments including the flow channel(s) 214, 216 in both the first and second metal plates 202, 206, a plurality of alignment features, such threaded rods, can be used to align the first and second metal plates 202, 206 during positioning (step 120). If the metal flow module 200 does not include integrated cooling (“No” at step 130), the method 100 includes the step 140 of heating the first and second metal plates 202, 206 together in a non-oxidizing atmosphere to thermally bond the contacting portions of the first and second major surfaces 204, 208. If the metal flow module includes integrated cooling (“Yes” at step 130), the method 100 proceeds to additional steps described later in the disclosure with reference to FIG. 8.

In a preferred embodiment, illustrated best in FIG. 7, the flow channel(s) 214 of the second metal plate 206 are aligned with the flow channel(s) 216 of the first metal plate 202 such that each of the flow channels 214, 216 defines a portion of at least one common flow channel 218 that extends through the metal flow module 200. The flow channel(s) 214, 216 preferably have edge fillets 217 at the intersections of adjacent sides of the channels. The edge fillets 217 reduce mechanical stress due to the pressures within the channels and improve the fluid flow through the channels.

The depth of the flow channel(s) 214, 216 along their respective or common path(s) can be symmetrical, asymmetrical, or include symmetrical and asymmetrical portions about a plane P (FIG. 7) defined by the first contacting portions of the first and second major surfaces 204, 208. In embodiments in which only one of the first and second metal plates 202, 206 has the flow channel(s), a depth of the channel from the plane P of the first contacting portions is up to approximately 7 mm or even up to approximately 10 mm. In further embodiments in which both the first and second metal plates 202, 206 have the flow channels(s), as shown in FIG. 7, a depth of each flow channel from the plane P of the first contacting portions is up to approximately 3.5 mm or even up to approximately 5 mm for a total distance between the axial-most surfaces of the channels of up to approximately 7 mm or even up to approximately 10 mm. The depth of the flow channel(s) from the plane P or the total depth of the flow channel(s) can be greater than 10 mm or smaller than 3.5 mm in further embodiments.

The metal for the first and second metal plates 202, 206 is 316L stainless steel, which has high corrosion performance and is readily available in various thicknesses and sizes. Other stainless steel metals can be used as well including Hastelloy®, as well as still other metals.

The flux is preferably carbide powder for preserving chemical resistance of the finished modules. Any carbide powder (silicon carbide, boron carbide, hafnium carbide, etc.), or mixtures thereof, can be used. It has been found that some nitride powders (silicon nitride) can bond as well, but carbide powder flux has better corrosion resistance relative to nitrides. The carbide powder or carbide powder mixture in some embodiments is deposited or sprinkled onto the first major surface so that there is complete coverage.

The carbide powder or carbide powder mixture forms a layer on the first major surface that in some embodiments has a monolayer-like thickness, which approximates the thickness of a single layer of the powder particles that form the flux. When the depth of the flow channel(s) is greater than 1 mm, or preferably greater than 2 mm, 3 mm, or 5 mm, the layer of carbide powder or carbide powder mixture can be deposited to a thickness that is greater than the monolayer-like thickness.

When the depth of the flow channel(s) is 1 mm or less, the layer of carbide powder or carbide powder mixture can be deposited in trace amounts on the first major surface. Additionally, the first and second majors surfaces 204, 208 should be smooth and flat to enable good contact between the first contacting portions. The preferred peak bonding temperature during heating of the first and second metal plates 202, 206 should be at least 1210° C. to promote increased ion diffusion therebetween.

The method in embodiments includes forming a flux retention feature configured to retain the powder flux in position after the flux is applied to a surface of the metal plates. The flux retention feature in embodiments is an adhesive that is misted onto the major surface of the metal plate prior to applying the powder. After the powder is applied on the adhesive, the excess powder is removed by rubbing it evenly across the major surface of the metal plate. In embodiments, the metal plates can include the flux retention feature in the form of a texture in the major surface thereof, for example, similar to the brushing finish applied to the surface of stainless steel appliances. The flux retention feature in yet further embodiment is a water-based mixture comprising the powder flux. The mixture can be applied to the major surface, for example, via brushing, rolling, spraying, or the like such that the mixture remains approximately in place on the major surface thereafter. The flux retention feature in further embodiments is used on any surface that receives the carbide powder or carbide powder mixture.

The flux bonding process requires that it take place in a non-oxidizing or in an inert atmosphere (argon, vacuum, etc.). For carbide powders the bonding process can adequately take place in 90 minutes at peak temperature. The preferred fluxing agent for lower sealing temperature is boron carbide since its peak bonding temperature of approximately 1210° C. is significantly lower than the peak bonding temperature of other carbide powders. For example, silicon carbide requires a peak flux bonding temperature of approximately 1340° C.

According to embodiments, the heating step can be performed while pressing the plates together, although bonding can be accomplished without external pressing. As the plates become relatively larger, it is preferred to mechanically fasten the plates together prior to heating, such as by joining the plates with screws or bolts positioned around the perimeter thereof

FIG. 2 shows a plate 206 for use in the disclosed method. The plate is stainless steel with a channel 214 formed in a major surface 208 of the plate, such as by machining. A major surface 212 of the plate 206, the surface 212 not being directly visible in the photograph of FIG. 2, is positioned opposite the major surface 208. The channel 214 has two inputs 219 and an output 220.

FIG. 3 shows a finished (sealed) module 200 after the heating step. Metal fluid connectors 221 have been added.

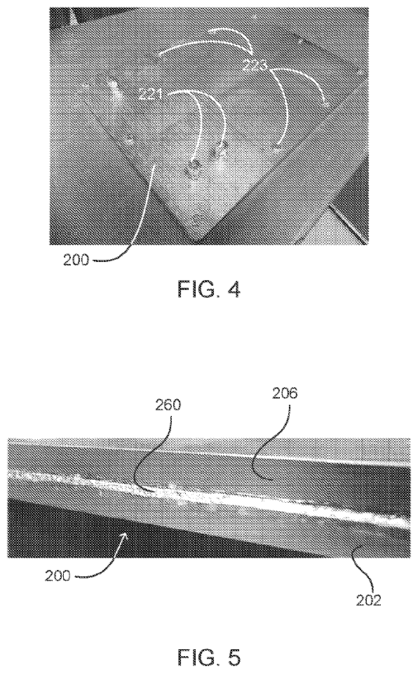

FIG. 4 shows another finished (sealed) module 200 after the heating step. The module 200 includes a plurality of fasteners 223 positioned at locations around the perimeter of the module 200 to hold the plates 202, 206 together and prevent warping or separation during heating. Metal fluid connectors 221 have again been added.

According to another aspect of the present method, the threads of the fluid connectors 221 (such as Swagelok® fittings) used for fluid inputs and outputs are coated with a flux material prior to threading them into the respective plate, prior to the heating step. This produces a permanent and durable seal between the fluid connectors 221 and the module 200. Without thermal flux-assisted bonding of the connectors into the plate, leaks can occur under high pressure. The flux for this purpose may take the form of a water-based paint mixture including silicon carbide and boron carbide powder.

For some applications, additional corrosion resistance is needed even relative to stainless steel. For such applications, a chemically resistant coating in the form of a carbide film, such as silicon carbide, is deposited on the surface portions defining the channels in the metal plate prior to plate positioning and heating and bonding process. In some embodiments, the carbide film is selectively applied only to the surfaces of the channels. In these embodiments, the carbide film can be applied via plasma deposition while the contacting portions of the metal plate are covered with a mask. Alternatively, the channels within the finished module are coated after heating and bonding.

As another aspect of the present disclosure, a flow module useful in a flow reactor or for other fluidic processing is provided, the flow module comprising a first metal plate having opposing first and second major surfaces and a second metal plate having opposing first and second major surfaces and one or more flow channels defined at least in part in the first major surface, the plates joined together with their respective first major surfaces facing each other by a flux bond.

As yet another aspect of the present disclosure, a flow module useful in a flow reactor or for other fluidic processing is provided, the flow module comprising a first metal plate having opposing first and second major surfaces and a second metal plate having opposing first and second major surfaces and one or more flow channels defined at least in part in the first major surface, the plates joined together with their respective first major surfaces facing each other by flux-assisted interdiffusion and/or co-melting of the facing surfaces.

FIG. 5 is a close up digital photograph of an edge of an embodiment of a flow module according to aspects of the present disclosure showing a seal between first and second plates 202, 206, of a module 200. As shown in the figure, flux-assisted interdiffusion and/or co-melting of the facing surfaces of the plates 202, 206, has occurred at the interface 260, producing a robust seal.

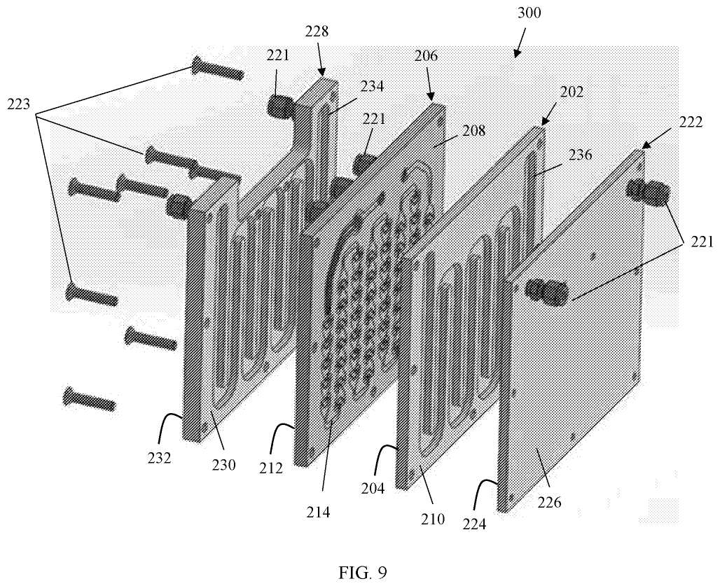

FIG. 8 illustrates a flow diagram of a continuation of the method 100 when the metal flow module includes integrated cooling. The method 100 is further described with reference to the metal flow module 300 shown in FIG. 9. The metal flow module 300 further includes a third metal plate 222 with a fifth major surface 224 and a sixth major surface 226 that is opposed to the fifth major surface 224. The metal flow module 300 also includes a fourth metal plate 228 with a seventh major surface 230 and an eight major surface 232 that is opposed to the seventh major surface 230. The fourth metal plate 228 also has one or more flow channels 234 defined at least in part in the seventh major surface 230. The first and second metal plates 202, 206 of the metal flow modules 200, 300 are essentially the same except the first metal plate 202 also has one or more flow channels 236 defined at least in part in the third major surface 210 and the flow channels 216 are preferably omitted from the first major surface 204.

The method 100 as shown in FIG. 8 further includes the step 150 of applying flux to the fifth major surface 224 of the third metal plate 222. The method 100 then includes the step 160 of positioning the third major surface 210 of the first metal plate 202 against the fifth major surface 224 of the third metal plate 206. In this arrangement, the third and fifth major surfaces 210, 224 face one another and the flux is positioned between second contacting portions of the third and fifth major surfaces. The method 100 then includes the step of 170 applying flux to the fourth major surface 212 of the second metal plate 206. The method 100 then includes the step 180 of positioning the seventh major surface 230 of the fourth metal plate 228 against the fourth major surface 212 of the second metal plate 206. In this arrangement, the fourth and seventh major surfaces 212, 230 face one another and the flux is positioned between third contacting portions of the fourth and seventh major surfaces. The method 100 then includes the step 190 of heating the first, second, third, and fourth metal plates 202, 206, 222, 228 together in a non-oxidizing atmosphere to thermally bond the first contacting portions of the first and second major surfaces 204, 208, the second contacting portions of the third and fifth major surfaces 210, 224, and the third contacting portions of the fourth and seventh major surfaces 212, 230.

The methods and modules of the present disclosure provide a low-cost method to produce a metal or stainless steel flow reactor module. If embedded fluid couplers are included, users have a simple way of connecting to the module, and the process of embedding is likewise simple and produces a robust seal between the couplers and the consolidated plate. The method also provides a flow reactor module which is sealed or enclosed without the use of organic materials such as gaskets or O-rings, allowing for performance high temperature processes or reactions, or other processes or reactions incompatible with organic materials.

A first aspect of the present disclosure includes a method of forming a metal flow module for a flow reactor, comprising forming a flux retention feature configured to retain flux in a position; applying the flux to one or more of a first major surface of a first metal plate and a second major surface of a second metal plate, the flux contacting the flux retention feature; positioning the first major surface and the second major surface against one another such that the flux is positioned between first contacting portions of the first and second major surfaces, wherein one or more flow channels are defined in at least one of the first major surface and the second major surface; and heating the first and second metal plates in a non-oxidizing atmosphere to thermally bond the first contacting portions.

A second aspect of the present disclosure includes a method according to the first aspect, wherein the one or more flow channels are defined at least in part in the first major surface and aligned with the one or more flow channels defined at least in part in the second major surface.

A third aspect of the present disclosure includes a method according to the first aspect, wherein the flux comprises one of carbide powder and nitride powder.

A fourth aspect of the present disclosure includes a method according to the third aspect, wherein the flux comprises boron carbide powder.

A fifth aspect of the present disclosure includes a method according to the first aspect, wherein heating the first and second metal plates includes simultaneously pressing the first and second metal plates together.

A sixth aspect of the present disclosure includes a method according to the first aspect, further comprising mechanically fastening the first and second metal plates together prior to heating.

A seventh aspect of the present disclosure includes a method according to the sixth aspect, wherein mechanically fastening the first and second metal plates together includes joining the first and second metal plates with fasteners positioned around a perimeter thereof

An eighth aspect of the present disclosure includes a method according to the sixth aspect, wherein mechanically fastening the first and second metal plates together includes joining the first and second metal plates with at least one fastener positioned at a center thereof.

A ninth aspect of the present disclosure includes a method according to the first aspect, further comprising coating at least portions of the first and second major surfaces with a chemically resistant coating.

A tenth aspect of the present disclosure includes a method according to the ninth aspect, wherein the portions correspond, defined as align to, to locations of the one or more flow channels.

An eleventh aspect of the present disclosure includes a method according to the ninth aspect, wherein the chemically resistant coating is a carbide coating.

A twelfth aspect of the present disclosure includes a method according to the first aspect, wherein the flux retention feature comprises an adhesive that is applied to the one or more of the first major surface and the second major surface prior to applying the flux.

A thirteenth aspect of the present disclosure includes a method according to the first aspect, wherein the flux retention feature comprises a texture in the one or more of the first major surface and the second major surface.

A fourteenth aspect of the present disclosure includes a method according to the first aspect, wherein the flux retention feature is a water-based mixture comprising the flux, the mixture configured to be applied to the one or more of the first major surface and the second major surface prior to positioning the first and second major surfaces against one another.

A fifteenth aspect of the present disclosure includes a method according to the first aspect, further comprising applying flux to one or more of a portion of a fluid connector and a port extending through at least one of the first and second metal plates, the port configured to fluidically communicate with the one or more flow channels from outside the metal flow module; connecting the fluid connector to the port such that the flux is positioned between second contacting portions of the portion of fluid connector and the one of the first and second metal plates; and heating the fluid connector and the first and second metal plates in the non-oxidizing atmosphere to thermally bond the first and second contacting portions.

A sixteenth aspect of the present disclosure includes a method according to the first aspect, further comprising applying flux to one or more of a third major surface, opposed to the second major surface, of the second metal plate and a fourth major surface of a third metal plate; positioning the third major surface and the fourth major surface against one another such that the flux is positioned between second contacting portions of the third and fourth major surfaces, wherein one or more flow channels are defined in at least one of the third major surface and the fourth major surface; and heating the first, second, and third metal plates in the non-oxidizing atmosphere to thermally bond the first and second contacting portions.

A seventeenth aspect of the present disclosure includes a method according to the sixteenth aspect, further comprising applying flux to one or more of a fifth major surface, opposed to the first major surface, of the first metal plate and a sixth major surface of a fourth metal plate; positioning the fifth major surface and the sixth major surface against one another such that the flux is positioned between third contacting portions of the fifth and sixth major surfaces, wherein one or more flow channels are defined in at least one of the fifth major surface and the sixth major surface; and heating the first, second, third, and fourth metal plates in the non-oxidizing atmosphere to thermally bond the first, second, and third contacting portions.

An eighteenth aspect of the present disclosure includes a method of forming a metal flow module for a flow reactor, comprising applying flux to one or more of a first major surface of a first metal plate and a second major surface of a second metal plate; positioning the first major surface and the second major surface against one another such that the flux is positioned between first contacting portions of the first and second major surfaces, wherein one or more flow channels are defined in at least one of the first major surface and the second major surface; applying the flux to one or more of a portion of a fluid connector and a port extending through at least one of the first and second metal plates, the port configured to fluidically communicate with the one or more flow channels from outside the metal flow module; connecting the fluid connector to the port such that the flux is positioned between second contacting portions of the portion of fluid connector and the at least one of the first and second metal plates; and heating the fluid connector and the first and second metal plates in the non-oxidizing atmosphere to thermally bond the first and second contacting portions.

A nineteenth aspect of the present disclosure includes a method according to the eighteenth aspect, further comprising forming a flux retention feature configured to retain the flux in a position, the flux contacting the flux retention feature in one or more of the first contacting portions and the second contacting portions.

A twentieth aspect of the present disclosure includes a method of forming a metal flow module for a flow reactor, comprising applying flux to one or more of a first major surface of a first metal plate and a second major surface of a second metal plate; positioning the first major surface and the second major surface against one another such that the flux is positioned between first contacting portions of the first and second major surfaces, wherein one or more flow channels are defined in at least one of the first major surface and the second major surface; applying flux to one or more of a third major surface, opposed to the first major surface, of the first metal plate and a fourth major surface of a third metal plate; positioning the third major surface and the fourth major surface against one another such that the flux is positioned between second contacting portions of the third and fourth major surfaces, wherein one or more flow channels are defined in at least one of the third major surface and the fourth major surface; and heating the first, second, and third metal plates in the non-oxidizing atmosphere to thermally bond the first and second contacting portions.

A twenty first aspect of the present disclosure includes a method according to the twentieth aspect, further comprising applying flux to one or more of a fifth major surface, opposed to the second major surface, of the second metal plate and a sixth major surface of a fourth metal plate; positioning the fifth major surface and the sixth major surface against one another such that the flux is positioned between third contacting portions of the fifth and sixth major surfaces, wherein one or more flow channels are defined in at least one of the fifth major surface and the sixth major surface; and heating the first, second, third, and fourth metal plates in the non-oxidizing atmosphere to thermally bond the first, second, and third contacting portions

A twenty second aspect of the present disclosure includes a method according to the twentieth aspect or the twenty first aspect, further comprising forming a flux retention feature configured to retain the flux in a position, the flux contacting the flux retention feature.

A twenty third aspect of the present disclosure includes a metal flow module for a flow reactor, comprising a first metal plate having a first major surface; and a second metal plate having a second major surface, wherein one or more flow channels are defined in one or more of the first major surface and the second major surface, and wherein the first and second metal plates are joined by a flux bond at first contacting portions of the first and second major surfaces.

A twenty fourth aspect of the present disclosure includes a metal flow module according to the twenty third aspect, further comprising a third metal plate having a third major surface, wherein one or more flow channels are defined in one or more of the third major surface and a fourth major surface, opposed to the first major surface, of the first metal plate, and wherein the first and third metal plates are joined by a flux bond at second contacting portions of the third and fourth major surfaces.

A twenty fifth aspect of the present disclosure includes a metal flow module according to the twenty fourth aspect, further comprising a fourth metal plate having a fifth major surface, wherein one or more flow channels are defined in one or more of the fifth major surface and a sixth major surface, opposed to the second major surface, of the second metal plate, and wherein the second and fourth metal plates are joined by a flux bond at third contacting portions of the fifth major surface and the sixth major surface.

A twenty sixth aspect of the present disclosure includes a metal flow module according to the twenty third aspect, further comprising a fluid connector joined by a flux bond at second contacting portions of the fluid connector and at least one of the first and second metal plates so as to fluidically communicate with the one or more flow channels.

A twenty seventh aspect of the present disclosure includes a method of forming a metal flow module for a flow reactor, comprising forming a flux retention feature on a first major surface of a first metal plate; applying flux to the first major surface, the flux retention feature configured to retain the flux at least in part on the first surface; positioning a second major surface of a second metal plate against the first major surface of the first metal plate, the second metal plate having one or more flow channels defined at least in part in the second major surface, the flux positioned between first contacting portions of the first and second major surfaces; and heating the first and second metal plates in a non-oxidizing atmosphere to thermally bond the first contacting portions.

A twenty eighth aspect of the present disclosure includes a method according to the twenty seventh aspect, wherein one or more flow channels are defined at least in part in the first major surface and aligned with the one or more flow channels defined at least in part in the second major surface.

A twenty ninth aspect of the present disclosure includes a method according to the twenty seventh aspect, wherein the flux comprises one of carbide powder and nitride powder.

A thirtieth aspect of the present disclosure includes a method according to the twenty ninth aspect, wherein the flux comprises boron carbide powder.

A thirty first aspect of the present disclosure includes a method according to the twenty seventh aspect, wherein heating the first and second metal plates includes simultaneously pressing the first and second metal plates together.

A thirty second aspect of the present disclosure includes a method according to the twenty seventh aspect, further comprising mechanically fastening the first and second metal plates together prior to heating.

A thirty third aspect of the present disclosure includes a method according to the thirty second aspect, wherein mechanically fastening the first and second metal plates together includes joining the first and second metal plates with fasteners positioned around a perimeter thereof.

A thirty fourth aspect of the present disclosure includes a method according to the thirty second aspect, wherein mechanically fastening the first and second metal plates together includes joining the first and second metal plates with at least one fastener positioned at a center thereof.

A thirty fifth aspect of the present disclosure includes a method according to the twenty seventh aspect, further comprising coating at least portions of the first and second major surfaces with a chemically resistant coating.

A thirty sixth aspect of the present disclosure includes a method according to the thirty fifth aspect, wherein the portions correspond, defined as align to, to locations of the one or more flow channels.

A thirty seventh aspect of the present disclosure includes a method according to the thirty fifth aspect, wherein the chemically resistant coating is a carbide coating.

A thirty eighth aspect of the present disclosure includes a method according to the twenty seventh aspect, further comprising applying flux to a portion of a fluid connector; connecting the fluid connector to one of the first and second metal plates so that the fluid connector fluidically communicates with the one or more flow channels, the flux positioned between second contacting portions of the portion of fluid connector and the one of the first and second metal plates; and heating the fluid connector and the first and second metal plates in the non-oxidizing atmosphere to thermally bond the first and second contacting portions.

A thirty ninth aspect of the present disclosure includes a method according to the twenty seventh aspect, further comprising applying flux to a third major surface, opposed to the second major surface, of the second metal plate; positioning a fourth major surface of a third metal plate against the third major surface of the second metal plate, the third metal plate having one or more flow channels defined at least in part in the fourth major surface, the flux positioned between second contacting portions of the third and fourth major surfaces; and heating the first, second, and third metal plates in the non-oxidizing atmosphere to thermally bond the first and second contacting portions.

A fortieth aspect of the present disclosure includes a method according to the twenty seventh aspect, further comprising applying flux to a third major surface of a third metal plate; positioning a fourth major surface, opposed to the first major surface, of the first metal plate against the third major surface of the third metal plate, the first metal plate having one or more flow channels defined at least in part in the fourth major surface, the flux positioned between second contacting portions of the third and fourth major surfaces; and heating the first, second, and third metal plates in the non-oxidizing atmosphere to thermally bond the first and second contacting portions.

A forty first aspect of the present disclosure includes a metal flow module for a flow reactor, comprising a first metal plate having a first major surface; a second metal plate having a second major surface and one or more flow channels defined at least in part in the second major surface, the first and second metal plates joined by a flux bond at first contacting portions of the first and second major surfaces.

A forty second aspect of the present disclosure includes a metal flow module according to the forty first aspect, further comprising a third metal plate having a third major surface and one or more flow channels defined at least in part in the third major surface, the second and third metal plates joined by a flux bond at second contacting portions of the third major surface and a fourth major surface, opposed to the second major surface, of the second metal plate.

A forty third aspect of the present disclosure includes a metal flow module according to the forty first aspect, further comprising a third metal plate having a third major surface, the first metal plate having one or more flow channels defined at least in part in a fourth major surface, opposed to the first major surface, of the first metal plate, the first and third metal plates joined by a flux bond at second contacting portions of the third and fourth major surfaces.

A forty fourth aspect of the present disclosure includes a metal flow module according to the forty third aspect, further comprising a fourth metal plate having a fifth major surface and one or more flow channels defined at least in part in the fifth major surface, the second and fourth metal plates joined by a flux bond at third contacting portions of the fifth major surface and a sixth major surface, opposed to the second major surface, of the second metal plate.

A forty fifth aspect of the present disclosure includes a metal flow module according to the forty first aspect, further comprising a fluid connector joined by a flux bond at second contacting portions of the fluid connector and at least one of the first and second metal plates so as to fluidically communicate with the one or more flow channels.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A method of forming a metal flow module for a flow reactor, comprising:
forming a flux retention feature configured to retain flux in a position;
applying the flux to one or more of a first major surface of a first metal plate and a second major surface of a second metal plate, the flux contacting the flux retention feature;
positioning the first major surface and the second major surface against one another such that the flux is positioned between first contacting portions of the first and second major surfaces, wherein one or more flow channels are defined in at least one of the first major surface and the second major surface; and
heating the first and second metal plates in a non-oxidizing atmosphere or an inert atmosphere to thermally bond the first contacting portions.

2. The method of claim 1, wherein the one or more flow channels are defined at least in part in the first major surface and aligned with the one or more flow channels defined at least in part in the second major surface.

3. The method of claim 1, wherein the flux comprises one of carbide powder and nitride powder.

4. The method of claim 3, wherein the flux comprises boron carbide powder.

5. The method of claim 1, wherein heating the first and second metal plates includes simultaneously pressing the first and second metal plates together.

6. The method of claim 1, further comprising mechanically fastening the first and second metal plates together prior to heating.

7. (canceled)

8. (canceled)

9. The method of claim 1, further comprising coating at least portions of the first and second major surfaces with a chemically resistant coating.

10. The method of claim 9, wherein the portions correspond, defined as align to, to locations of the one or more flow channels.

11. (canceled)

12. The method of claim 1, wherein the flux retention feature comprises an adhesive that is applied to the one or more of the first major surface and the second major surface prior to applying the flux.

13. The method of claim 1, wherein the flux retention feature comprises a texture in the one or more of the first major surface and the second major surface.

14. The method of claim 1, wherein the flux retention feature is a water-based mixture comprising the flux, the mixture configured to be applied to the one or more of the first major surface and the second major surface prior to positioning the first and second major surfaces against one another.

15. The method of claim 1, further comprising:
applying flux to one or more of a portion of a fluid connector and a port extending through at least one of the first and second metal plates, the port configured to fluidically communicate with the one or more flow channels from outside the metal flow module;
connecting the fluid connector to the port such that the flux is positioned between second contacting portions of the portion of fluid connector and the one of the first and second metal plates; and
heating the fluid connector and the first and second metal plates in the non-oxidizing atmosphere or the inert atmosphere to thermally bond the first and second contacting portions.

16. The method of claim 1, further comprising:
applying flux to one or more of a third major surface, opposed to the second major surface, of the second metal plate and a fourth major surface of a third metal plate;
positioning the third major surface and the fourth major surface against one another such that the flux is positioned between second contacting portions of the third and fourth major surfaces, wherein one or more flow channels are defined in at least one of the third major surface and the fourth major surface; and
heating the first, second, and third metal plates in the non-oxidizing atmosphere or the inert atmosphere to thermally bond the first and second contacting portions.

17. The method of claim 16, further comprising:
applying flux to one or more of a fifth major surface, opposed to the first major surface, of the first metal plate and a sixth major surface of a fourth metal plate;
positioning the fifth major surface and the sixth major surface against one another such that the flux is positioned between third contacting portions of the fifth and sixth major surfaces, wherein one or more flow channels are defined in at least one of the fifth major surface and the sixth major surface; and
heating the first, second, third, and fourth metal plates in the non-oxidizing atmosphere or the inert atmosphere to thermally bond the first, second, and third contacting portions.

18. A method of forming a metal flow module for a flow reactor, comprising:
applying flux to one or more of a first major surface of a first metal plate and a second major surface of a second metal plate;
positioning the first major surface and the second major surface against one another such that the flux is positioned between first contacting portions of the first and second major surfaces, wherein one or more flow channels are defined in at least one of the first major surface and the second major surface;
applying the flux to one or more of a portion of a fluid connector and a port extending through at least one of the first and second metal plates, the port configured to fluidically communicate with the one or more flow channels from outside the metal flow module;
connecting the fluid connector to the port such that the flux is positioned between second contacting portions of the portion of fluid connector and the at least one of the first and second metal plates; and
heating the fluid connector and the first and second metal plates in a non-oxidizing atmosphere or an inert atmosphere to thermally bond the first and second contacting portions.

19. The method of claim 18, further comprising forming a flux retention feature configured to retain the flux in a position, the flux contacting the flux retention feature in one or more of the first contacting portions and the second contacting portions.

20. (canceled)

21. (canceled)

22. (canceled)

23. A metal flow module for a flow reactor, comprising:
a first metal plate having a first major surface; and
a second metal plate having a second major surface, wherein one or more flow channels are defined in one or more of the first major surface and the second major surface, and wherein the first and second metal plates are joined by a flux bond at first contacting portions of the first and second major surfaces.

24. The flow module of claim 23, further comprising:
a third metal plate having a third major surface, wherein one or more flow channels are defined in one or more of the third major surface and a fourth major surface, opposed to the first major surface, of the first metal plate, and wherein the first and third metal plates are joined by a flux bond at second contacting portions of the third and fourth major surfaces.

25. The flow module of claim 24, further comprising:
a fourth metal plate having a fifth major surface, wherein one or more flow channels are defined in one or more of the fifth major surface and a sixth major surface, opposed to the second major surface, of the second metal plate, and wherein the second and fourth metal plates are joined by a flux bond at third contacting portions of the fifth major surface and the sixth major surface.

26. The flow module of claim 23, further comprising a fluid connector joined by a flux bond at second contacting portions of the fluid connector and at least one of the first and second metal plates so as to fluidically communicate with the one or more flow channels.

27-45. (canceled)
